(19) United States
(12) Patent Application Publication
(10) Pub. No.: US 2009/0315510 A1
(43) Pub. Date: Dec. 24, 2009

(54) Battery Monitoring and Maintenance for Medical Device

(76) Inventor: Cesario Dos Santos, Aliso Viejo, CA (US)

Correspondence Address: ALCON, IP LEGAL, TB4-8, 6201 SOUTH FREEWAY, FORT WORTH, TX, 76134, US

(21) Appl. No.: 12/375,481

(22) PCT Filed: Aug. 2, 2007
(86) PCT No.: PCT/US07/75096

§ 371 Date: Jan. 28, 2009

Related U.S. Application Data
(63) Continuation of application No. 11/498,400, filed on Aug. 3, 2006.

(51) Int. Cl. H02J 7/00; H02J 7/04

(52) U.S. Cl. 320/107; 320/165

(57) ABSTRACT

A safety charging system for a battery-operated medical device includes a power source, a clock for providing a current date, and a charging base. A first connection arrangement is coupled to the power source, and facilitates an electrical and data connection with the charging base. The charging base charges the power source. The charging base has charge circuitry and a second connection arrangement for facilitating an electrical and data connection between the power source and the charging base. Control logic implements maintenance and charging of the power source.

### RELATED APPLICATIONS

This Application is a continuation-in-part of U.S. patent application Ser. No. 11/498,400 filed Aug. 3, 2006.

### BACKGROUND OF THE INVENTION

The present invention relates to a medical device and more particularly to monitoring and maintaining a battery in a battery operated medical device.

Several diseases and conditions of the posterior segment of the eye threaten vision. Age related macular degeneration (ARMD), choroidal neovascularization (CNV), retinopathies (e.g., diabetic retinopathy, vitreoretinopathy), retinitis (e.g., cytomegalovirus (CMV) retinitis), uveitis, macular edema, glaucoma, and neuropathies are several examples.

These, and other diseases, can be treated by injecting a drug into the eye. Such injections are typically manually made using a conventional syringe and needle. In using such a syringe, the surgeon is required to pierce the eye tissue with the needle, hold the syringe steady, and actuate the syringe plunger (with or without the help of a nurse) to inject the fluid into the eye. The volume injected is typically not controlled in an accurate manner due to parallax error during reading the vernier on the syringe. Fluid flow rates are uncontrolled. Tissue damage may occur due to an “unsteady” injection. Reflux of the drug may also occur when the needle is removed from the eye.

An effort has been made to control the delivery of small amounts of liquids. A commercially available fluid dispenser is the ULTRA™ positive displacement dispenser available from EFD Inc. of Providence, R.I. The ULTRA dispenser is typically used in the dispensing of small volumes of industrial adhesives. It utilizes a conventional syringe and a custom dispensing tip. The syringe plunger is actuated using an electrical stepper motor and an actuating fluid. Parker Hannifin Corporation of Cleveland, Ohio distributes a small volume liquid dispenser for drug discovery applications made by Aurora Instruments LLC of San Diego, Calif. The Parker/Aurora dispenser utilizes a piezo-electric dispensing mechanism. Ypsomed, Inc. of Switzerland produces a line of injection pens and automated injectors primarily for the self-injection of insulin or hormones by a patient. This product line includes simple disposable pens and electronically-controlled motorized injectors.

U.S. Pat. No. 6,290,690 discloses an ophthalmic system for injecting a viscous fluid (e.g. silicone oil) into the eye while simultaneously aspirating a second viscous fluid (e.g. perflourocarbon liquid) from the eye in a fluid/fluid exchange during surgery to repair a retinal detachment or tear. The system includes a conventional syringe with a plunger. One end of the syringe is fluidly coupled to a source of pneumatic pressure that provides a constant pneumatic pressure to actuate the plunger. The other end of the syringe is fluidly coupled to an infusion cannula via tubing to deliver the viscous fluid to be injected.

It would be desirable to have a portable hand piece for reliably injecting a drug into the eye. Such a portable hand piece can utilize a power source, such as a battery. It would be desirable to maintain the battery so that the injection procedure can be performed reliably. Monitoring and maintenance of the battery can also prevent patient harm that might be caused by an incomplete or improperly administered injection.

### SUMMARY OF THE INVENTION

In one embodiment consistent with the principles of the present invention, the present invention is a safety charging system for a battery-operated medical device. The system includes a power source, a clock for providing a current date, and a charging base. A first connection arrangement is coupled to the power source, and facilitates an electrical and data connection with the charging base. The charging base charges the power source. The charging base has charge circuitry and a second connection arrangement for providing an electrical and data connection between the power source and the charging base. Control logic implements maintenance and charging of the power source.

In another embodiment consistent with the principles of the present invention, the present invention is a method of determining whether a power source has expired. The method includes recognizing a connection between a power source and a charging base; reading a current date; comparing the current date to a date associated with the power source; and determining if the power source has exceeded its useful life.

In another embodiment consistent with the principles of the present invention, the present invention is a method of maintaining a power source. The method includes recognizing a connection between a power source and a charging base; charging the power source; after the power source is charged, discharging the power source; monitoring a real time capacity of the power source while it is being discharged; and determining if the power source is within specification.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a perspective view of a charging base according to an embodiment of the present invention.

FIG. 2 is a perspective view of a battery-operated surgical hand piece according to an embodiment of the present invention.

FIG. 3 is an exploded cross section view of a charging base and battery pack or hand piece according to an embodiment of the present invention.

FIG. 4 is a cross section view of a disposable tip segment and a limited reuse assembly according to an embodiment of the present invention.

FIG. 5 is a cross section view of a limited reuse assembly according to an embodiment of the present invention.

FIG. 6 is a cross section view of a limited reuse assembly according to an embodiment of the present invention.

FIG. 7 is a cross section view of a charging base and the limited reuse assembly of FIG. 6 attached to a tip segment.

FIG. 8 is a flow chart of one method of determining when a power source has expired according to the principles of the present invention.

FIG. 9 is a flow chart of one method of maintaining a power source according to the principles of the present invention.

FIG. 10 is a flow chart of one method of maintaining a power source according to the principles of the present invention.

FIG. 11 is a flow chart of one method of maintaining a power source according to the principles of the present invention.

FIG. 12 is a flow chart of one method of maintaining a power source according to the principles of the present invention.

### DETAILED DESCRIPTION OF THE PREFERRED EMBODIMENTS

Reference is now made in detail to the exemplary embodiments of the invention, examples of which are illustrated in the accompanying drawings. Wherever possible, the same reference numbers are used throughout the drawings to refer to the same or like parts.

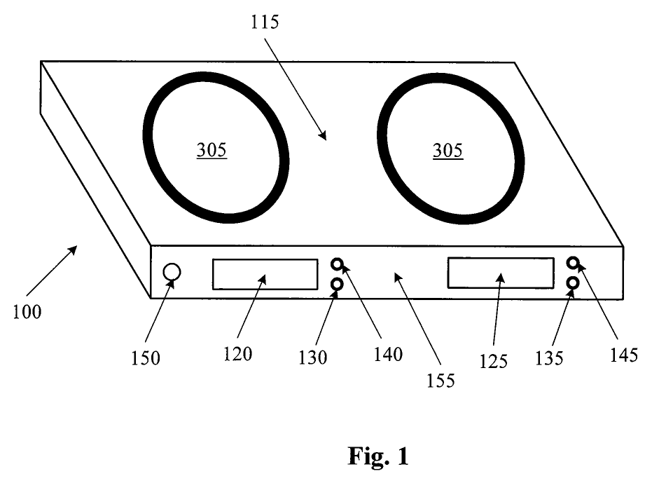

FIG. 1 is a perspective view of a charging base according to an embodiment of the present invention. Charging base 100 includes two holders 105, 110 disposed on its top surface 115. These holders 105, 110 are each designed to receive a battery pack or limited reuse assembly (not shown). The battery packs or limited reuse assemblies (not shown) rest in holders 105, 110. Holders 105, 110 are designed to locate the battery packs on the top surface 115 of charging base 100 to enable an electrical and data connection between the battery packs or limited reuse assemblies (not shown) and the charging base 100. Holders 105, 110 are also designed to locate the battery packs (not shown) on top surface 115 so that charging can take place.

Front surface 155 of charging base 100 has a power indicator 150, two displays 120, 125, two “charging” indicators 130, 135, and two “charge complete” indicators 140, 145. Power indicator 150 is a light emitting diode (LED) that is illuminated when the charging base is turned on or powered.

“Charging” indicator 130 is associated with holder 105. “Charging” indicator 135 is associated with holder 110. When charging base 100 is charging a battery pack or limited reuse assembly located in holder 105, “charging” indicator 130 is illuminated. Likewise, when charging base 100 is charging a battery pack or limited reuse assembly located in holder 110, “charging” indicator 135 is illuminated. “Charging” indicators 130, 135 can be implemented with LEDs.

“Charge complete” indicator 140 is associated with holder 105, and “charge complete” indicator 145 is associated with holder 110. When charging base 100 has finished charging a battery pack or limited reuse assembly located in holder 105, “charge complete” indicator 140 is illuminated. Likewise, when charging base 100 has finished charging a battery pack or limited reuse assembly located in holder 110, “charge complete” indicator 145 is illuminated. “Charging” indicators 140, 145 can be implemented with LEDs.

Display 120 is associated with holder 105, and display 125 is associated with holder 110. Display 120 provides information about the battery pack or limited reuse assembly located in holder 105. Likewise, display 125 provides information about the battery pack or limited reuse assembly located in holder 110. Displays 120, 125 can be any type of small display capable of displaying numbers. One such display is a simple seven segment liquid crystal display. In another embodiment, displays 120, 125 are capable of displaying letters in addition to numbers. In this manner, displays 120, 125 can provide information to a user of charging base 100.

The indicators and displays depicted in FIG. 1 are exemplary. Any number of different indicators and displays may be used with charging base 100. In addition, the configuration of the holders 105, 110 are exemplary as well. The algorithms detailed below may be implemented with any of a number of different charging base configurations.

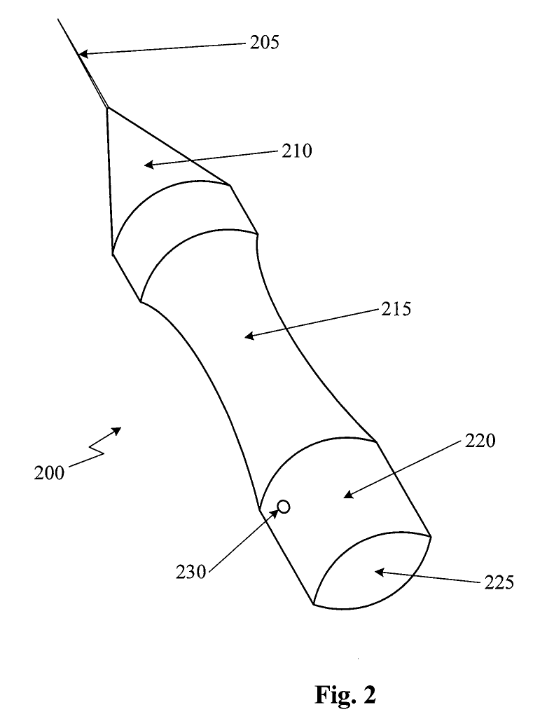

FIG. 2 is a perspective view of a battery-operated surgical hand piece according to an embodiment of the present invention. Hand piece 200 includes a working tip 205, top end 210, body 215, battery pack 220, and optional indicator 230. Working tip 205 is located at one end of the hand piece above top end 210. In one embodiment, working tip 205 is designed to be inserted into the eye during ophthalmic surgery. If hand piece 200 is a drug delivery device, then working tip 205 includes a needle designed to administer a dosage of a drug to the eye. Body 215 is designed to be held in the hand by a surgeon.

Battery pack 220 is located on the end of hand piece 200 opposite the working tip 205. Battery pack 220 may be integrated into hand piece 200, or it may be removable from body 215. If removable, battery pack 220 is designed to power numerous different hand pieces. In this manner, battery pack 220 is a universal battery pack for use with several different battery-powered hand pieces. In such a case, battery pack 220 has electrical and mechanical connectors (not shown) that couple the battery pack to hand piece body 215. Likewise, body 215 has electrical and mechanical connectors (not shown) designed to couple with the connectors on battery pack 220. The same connectors found on body 215 are also found on other hand pieces designed to operate with battery pack 220. In this system, a single battery pack can be used with different hand pieces. If the battery pack 220 is no longer operable, then a new battery pack can be coupled to the hand piece body 215. Since batteries have limited lives, and in general, lives much shorter than the hand piece body itself, a system that uses a universal battery pack allows the hand piece body 215 to be used for longer periods of time. In addition, it is easy to change the battery pack 220 if it is of a universal type.

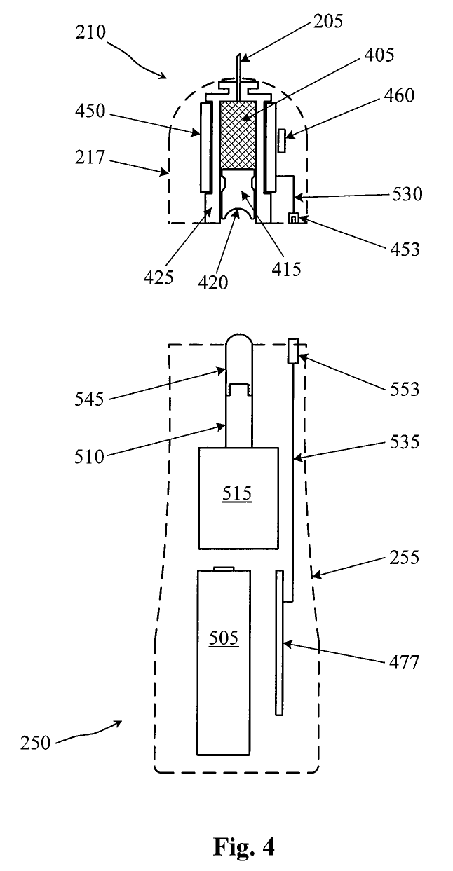

In the same manner, working tip 205 and top end 210 may be removable from the body 215 of hand piece 200. Different working tips and top ends may be used with body 215. In such a case, the hand piece body 215 is a universal body for use with different working tips as described more completely in FIG. 4.

Indicator 230 is optional. In this embodiment, indicator 230 is an LED that illuminates when the battery pack needs to be replaced. When the battery pack 220 is no longer able to be safely charged, indicator 230 is illuminated and battery pack 230 is disabled. Bottom surface 225 is designed to rest in holder 105 or holder 110 located on top surface 115 of the charging base 100 of FIG. 1.

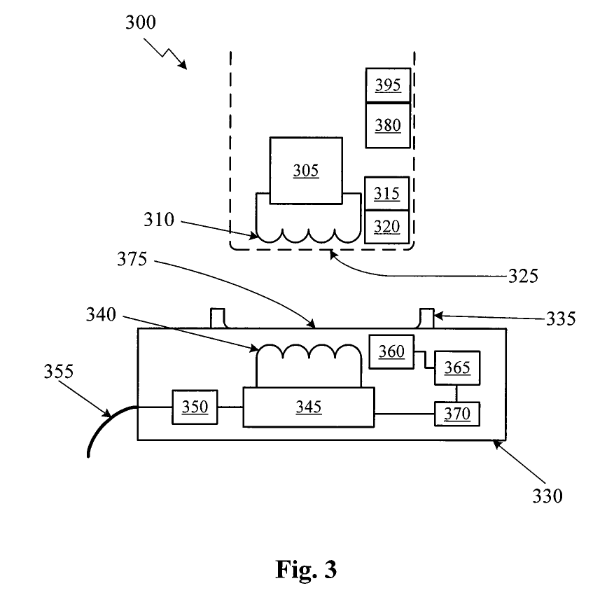

FIG. 3 is an exploded cross section view of a charging base and battery pack or section of a hand piece or limited reuse assembly according to an embodiment of the present invention. In FIG. 3, battery pack 300 is designed to rest on charging base 330. Battery pack 300 includes battery 305, secondary coil 310, RFID tag integrated circuit 315, RFID tag antenna 320, battery charge control circuitry 380, and clock 395. Charging base 330 includes circular holder rim 335, primary coil 340, base charge control circuitry 345, power conditioning circuitry 350, power line 355, RFID reader antenna 360, RFID reader circuitry 365, and control logic 370.

Battery pack 300 is in the shape of a cylinder. As described with reference to FIG. 2, battery pack 300 may be a universal battery pack that is removable from the hand piece. In this manner, the battery pack itself can be removed from the hand piece so that it can be charged. When the bottom surface 325 of battery pack 300 is resting on the top surface 375 of charging base 330, the battery pack is engaged in circular holder rim 335. In this position, the RFID reader antenna 360 is located close to the RFID tag antenna 320 enabling a communications link to be established.

In this manner, an RFID system allows the transfer of information, such as a charge count, a charge level, a time, a date, or other information, to take place between battery pack 300 and charging base 330. Battery pack 300 has an RFID tag which includes an RFID tag integrated circuit (IC) 315 and an RFID tag antenna 320. RFID tag IC 315 typically includes memory in which information, such as a charge count, can be stored. In addition, RFID tag IC 315 may store other information such as a product identifier. RFID tag antenna may be located anywhere near bottom surface 320 of battery pack 300. In order to improve the read and write capabilities of the RFID system, it is desirable to locate RFID tag antenna 315 at a location near the bottom surface 325 of battery pack 300 so that when the battery pack 300 is resting on top surface 375 of charging base 330, RFID tag antenna 315 is close to RFID reader antenna 360.

The RFID reader portion of the RFID system is contained in charging base 330. RFID reader antenna 360 is located close to the top surface 375 of charging base 330. RFID reader circuitry 365 is also located in charging base 330. RFID reader circuitry 365 is designed to read information from the RFID tag.

In one type of RFID system, a passive RFID system, the RFID tag does not have an internal power supply. Instead, the passive RFID tag relies on the electromagnetic field produced by the RFID reader circuitry 365 for its power. The electromagnetic field produced by the RFID reader circuitry 365 and emitted from the RFID reader antenna 360 induces an small electrical current in the RFID tag antenna 320. This small electrical current allows the RFID tag IC 315 to operate. In this passive system, the RFID tag antenna 320 is designed to both collect power from the electromagentic field produced by the RFID reader circuitry 365 and emitted by the RFID reader antenna 360 and to transmit an outbound signal that is received by the RFID reader antenna 360.

In operation, the RFID reader antenna 360 transmits a signal produced by the RFID reader circuitry 365. The RFID tag antenna 320 receives this signal and a small current is induced in the RFID tag antenna 320. This small current powers RFID tag IC 315. RFID tag IC 315 can then transmit a signal through RFID tag antenna 320 to RFID reader antenna 360 and RFID reader circuitry 365. In this manner, the RFID tag and the RFID reader can communicate with each other over a radio frequency link. RFID tag IC 315 transmits information, such as the charge count or the charge level of the battery 305, through RFID tag antenna 320 to the RFID reader. This information is received by RFID reader antenna 360 and RFID reader circuitry 365. In this manner, information can be transferred from the battery pack 300 to the charging base 330.

The RFID reader can transmit information to the RFID tag in a similar fashion. For example, RFID reader circuitry 365 can transmit a new charge count over the radio frequency signal emitted by RFID reader antenna 360. RFID tag antenna 320 receives this radio frequency signal with the new charge count. RFID tag IC 315 can then store the new charge count in its memory. In addition, the RFID system need not be passive. The RFID tag may be powered by battery 305.

While the present invention is described as having an RFID system, any other type of wireless or wired system can be used to transfer information between the battery pack 300 and the charging base 330. For example, a Bluetooth protocol may be used to establish a communications link between the battery pack and the charging base. Information can then be transferred between the battery pack 300 and the charging base 330 over this communications link. If the system utilizes a Bluetooth protocol, then blocks 315, 320, 360, and 365 contain the circuitry for Bluetooth communications. Other embodiments used to transfer information include an infrared protocol, 802.11, firewire, other wireless protocol, or wired protocol (for example, a USB or mini-USB connection). Likewise, blocks 315, 320, 360, and 365 contain the circuitry for these other types of communications.

When the bottom surface 325 of battery pack 300 is resting on the top surface 375 of charging base 330, the battery pack is engaged in circular holder rim 335. In this position, as noted, the RFID reader antenna 360 is located close to the RFID tag antenna 320 enabling a communications link to be established. In addition, primary coil 340 is aligned with secondary coil 310 to allow charging to take place.

In the embodiment shown in FIG. 3, an inductive charging circuit is shown. Inductive charging utilizes a transformer that is essentially split into two parts. The primary coil 340 of the transformer is located in the charging base 330 close to its top surface 375. The secondary coil of the transformer 310 is located in the battery pack 300 close to its bottom surface 325. When the charging base is connected to AC power through power line 355, the primary coil 340 is energized. When the secondary coil 310 is placed on the top surface 375 of the charging base 330, a current is induced in the secondary coil 310. This current charges battery 305.

Other elements of the charging circuit include power conditioning circuitry 350, base charge control circuitry 345, and battery charge control circuitry 380. Power conditioning circuitry 350 may have elements for surge protection and filtering. Base charge control circuitry 345 and battery charge control circuitry 380 control the charging method used to charge battery 305. As is known, different charging algorithms are suitable for different types of batteries. If battery 305 is a lithium ion battery, then an algorithm that ensures that the battery 305 is not over charged or subject to an over voltage condition is appropriate. In other words, for a lithium ion battery, a voltage limit algorithm is appropriate.

Clock 395 provides information by which the time that a battery pack has been in service can be determined. Clock 395 may be a real time clock that provides the actual time and/or date. In this case, the amount of time that battery 305 has been in service can be ascertained from the current date and/or time and the date and/or time that the battery was manufactured or placed in service. For example, the manufacturing date (and time, if applicable) may be stored in a memory device (not shown) or in charge control circuitry 380. Clock 395 may also be incorporated into charge control circuitry 380. In another embodiment of the present invention, clock 395 is located in charging base 330 and not in battery pack 300. In other embodiment of the present invention, clock 395 is located in a limited reuse assembly.

Charging base 330 also contains control logic 370. Control logic 370 (and/or charge control circuitry 380) is designed to implement the various safety algorithms described in more detail below. In operation, control logic 370 activates various indicators on the front surface 155 of charging base 100. Control logic 370 also turns the charging process on and off and controls the reading and writing of information, such as a charge count, between the battery pack 300 and the charging base 330.

FIG. 4 is cross section view of a disposable tip segment and a limited reuse assembly according to an embodiment of the present invention. In this embodiment, a disposable tip segment 210 is connectable to and removable from a limited reuse assembly 250. FIG. 4 shows how tip segment 210 interfaces with limited reuse assembly 250. In the embodiment of FIG. 4, tip segment 210 includes plunger interface 420, plunger 415, dispensing chamber housing 425, tip segment housing 217, temperature control device 450, thermal sensor 460, needle 205, dispensing chamber 405, interface 530, and tip interface connector 453. Limited reuse assembly 250 includes mechanical linkage interface 545, actuator shaft 510, actuator 515, power source 505, controller 477, limited reuse assembly housing 255, interface 535, and limited reuse assembly interface connector 553.

In tip segment 210, plunger interface 420 is located on one end of plunger 415. The other end of plunger 415 forms one end of dispensing chamber 405. Plunger 415 is adapted to slide within dispensing chamber 405. The outer surface of plunger 415 is fluidly sealed to the inner surface of dispensing chamber housing 425. Dispensing chamber housing 425 surrounds the dispensing chamber 405. Typically, dispensing chamber housing 425 has a cylindrical shape. As such, dispensing chamber 405 also has a cylindrical shape.

Needle 205 is fluidly coupled to dispensing chamber 405. In such a case, a substance contained in dispensing chamber 405 can pass through needle 205 and into an eye. Temperature control device 450 at least partially surrounds dispensing chamber housing 425. In this case, temperature control device 450 is adapted to heat and/or cool dispensing chamber housing 425 and any substance contained in dispensing chamber 405. Interface 530 connects temperature control device 450 with tip interface connector 453.

Optional thermal sensor 460 provides temperature information to assist in controlling the operation of temperature control device 450. Thermal sensor 460 may be located near dispensing chamber housing 425 and measure a temperature near dispensing chamber housing 425 or may be located in thermal contact with dispensing chamber housing 425, in which case it measures a temperature of dispensing chamber housing 425. Thermal sensor 460 may be any of a number of different devices that can provide temperature information. For example, thermal sensor 460 may be a thermocouple or a resistive device whose resistance varies with temperature. Thermal sensor is also electrically coupled to interface 530 or other similar interface.

The components of tip segment 210, including dispensing chamber housing 425, temperature control device 450, and plunger 415 are at least partially enclosed by tip segment housing 217. In one embodiment consistent with the principles of the present invention, plunger 415 is sealed to the interior surface of dispensing chamber housing 425. This seal prevents contamination of any substance contained in dispensing chamber 405. For medical purposes, such a seal is desirable. This seal can be located at any point on plunger 415 or dispensing chamber housing 425.

In limited reuse assembly 250, power source 505 provides power to actuator 515. An interface (not shown) between power source 505 and actuator 515 serves as a conduit for providing power to actuator 515. Actuator 515 is connected to actuator shaft 510. When actuator 515 is a stepper motor, actuator shaft 510 is integral with actuator 515. Mechanical linkage interface 545 is connected to actuator shaft 510. In this configuration, as actuator 515 moves actuator shaft 510 upward toward needle 205, mechanical linkage interface 545 also moves upward toward needle 205. In other embodiments of the present invention, mechanical linkage interface 545 and actuator shaft 510 are a single component. In other words, a shaft connected to actuator 515 includes both actuator shaft 510 and mechanical linkage interface 545 as a single assembly.

In limited reuse assembly 250, power source 505 is typically a rechargeable battery, such as a lithium ion battery, although other types of batteries may be employed. In addition, any other type of power cell is appropriate for power source 505. Optionally, power source 505 can be removed from housing 255 through a door or other similar feature (not shown).

Controller 477 is connected via interface 535 to limited reuse assembly interface connecter 553. Limited reuse assembly interface connecter 553 is located on a top surface of limited reuse assembly housing 255 adjacent to mechanical linkage interface 545. In this manner, both limited reuse assembly interface connector 553 and mechanical linkage interface 545 are adapted to be connected with tip interface connector 453 and plunger interface 420, respectively.

Controller 477 and actuator 515 are connected by an interface (not shown). This interface (not shown) allows controller 477 to control the operation of actuator 515. In addition, an interface between power source 505 and controller 477 allows controller 477 to control operation of power source 505. In such a case, controller 477 may control the charging and the discharging of power source 505 when power source 505 is a rechargeable battery.

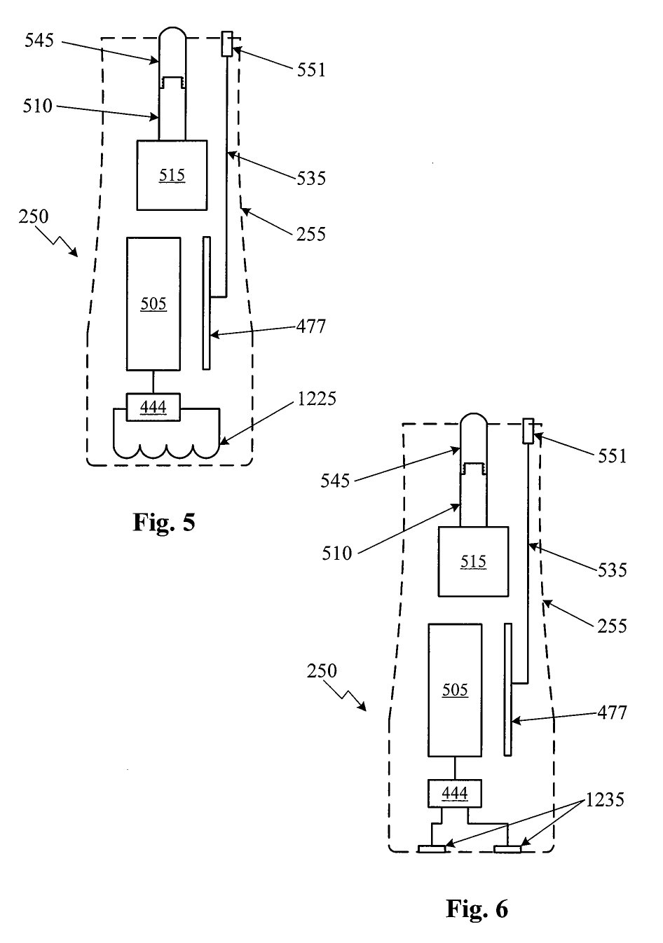

Controller 477 is typically an integrated circuit with power, input, and output pins capable of performing logic functions. In various embodiments, controller 477 is a targeted device controller. In such a case, controller 477 performs specific control functions targeted to a specific device or component, such as a temperature control device or a power supply. For example, a temperature control device controller has the basic functionality to control a temperature control device. In other embodiments, controller 477 is a microprocessor. In such a case, controller 477 is programmable so that it can function to control more than one component of the device. In other cases, controller 477 is not a programmable microprocessor, but instead is a special purpose controller configured to control different components that perform different functions. While depicted as one component in FIG. 5, controller 477 may be made of many different components or integrated circuits.

Tip segment 210 is adapted to mate with or attach to limited reuse assembly 250. In the embodiment of FIG. 4, plunger interface 420 located on a bottom surface of plunger 415 is adapted to mate with mechanical linkage interface 545 located near a top surface of limited reuse assembly housing 255. In addition, tip interface connector 453 is adapted to connect with limited reuse assembly interface connector 553. When tip segment 210 is connected to limited reuse assembly 250 in this manner, actuator 515 and actuator shaft 510 are adapted to drive plunger 415 upward toward needle 205. In addition, an interface is formed between controller 477 and temperature control device 450. A signal can pass from controller 477 to temperature control device 450 through interface 535, limited reuse assembly interface connector 553, tip interface connector 453, and interface 530.

In operation, when tip segment 210 is connected to limited reuse assembly 250, controller 477 controls the operation of actuator 515. When actuator 515 is actuated, actuator shaft 510 is moved upward toward needle 205. In turn, mechanical linkage interface 545, which is mated with plunger interface 420, moves plunger 415 upward toward needle 205. A substance located in dispensing chamber 405 is then expelled through needle 205.

In addition, controller 477 controls the operation of temperature control device 450. Temperature control device 450 is adapted to heat and/or cool dispensing chamber housing 425 and its contents. Since dispensing chamber housing 425 is at least partially thermally conductive, heating or cooling dispensing chamber housing 425 heats or cools a substance located in dispensing chamber 405. Temperature information can be transferred from thermal sensor 460 through interface 530, tip interface connector 453, limited reuse assembly interface connector 553, and interface 535 back to controller 477. This temperature information can be used to control the operation of temperature control device 450. When temperature control device 450 is a heater, controller 477 controls the amount of current that is sent to temperature control device 450. The more current sent to temperature control device 450, the hotter it gets. In such a manner, controller 477 can use a feed back loop utilizing information from thermal sensor 460 to control the operation of temperature control device 450. Any suitable type of control algorithm, such as a proportional integral derivative (PID) algorithm, can be used to control the operation of temperature control device 450.

A substance to be delivered into an eye, typically a drug suspended in a phase transition compound, is located in dispensing chamber 405. In this manner, the drug and phase transition compound are contacted by the inner surface of dispensing chamber housing 425. The phase transition compound is in a solid or semi-solid state at lower temperatures and in a more liquid state at higher temperatures. Such a compound can be heated by the application of current to temperature control device 450 to a more liquid state and injected into the eye where it forms a bolus that erodes over time.

Likewise, a reverse gelation compound may be used. A reverse gelation compound is in a solid or semi-solid state at higher temperatures and in a more liquid state at lower temperatures. Such a compound can be cooled by temperature control device 450 to a more liquid state and injected into the eye where it forms a bolus that erodes over time. As such, temperature control device 450 may be a device that heats a substance in dispensing chamber 405 or a device that cools a substance in dispensing chamber 405 (or a combination of both). After being delivered into the eye, a phase transition compound or reverse gelation compound erodes over time providing a quantity of drug over an extended period of time. Using a phase transition compound or reverse gelation compound provides better drug dosage with fewer injections.

In one embodiment of the present invention, the substance located in dispensing chamber 405 is a drug that is preloaded into the dispensing chamber. In such a case, tip segment 210 is appropriate as a single use consumable product. Such a disposable product can be assembled at a factory with a dosage of a drug installed.

While shown as a two-piece device, the injection system of FIG. 4 may be a single piece device. In such a case, the tip segment is integrated into the limited reuse assembly to form a single medical device.

FIG. 5 is a cross section view of a limited reuse assembly according to an embodiment of the present invention. In FIG. 5, limited reuse assembly 250 includes mechanical linkage interface 545, actuator shaft 510, actuator 515, power source 505, controller 477, limited reuse assembly housing 255, interface 535, limited reuse assembly interface connector 551, power source controller 444, and inductive element 1225.

The embodiment of FIG. 5 includes power source controller 444 and inductive element 1225. These two components control the charging of power source 505 when power source 505 is, for example, a rechargeable battery. Power source controller 444 includes circuitry that may perform any of a number of different functions related to the charging, monitoring, and maintenance of power source 505. In other embodiments, power source controller 444 may be implemented in or integrated into controller 477.

In one embodiment of the present invention, power source controller 444 (or controller 477, as the case may be) implements the various algorithms described below. In other embodiments of the present invention power source controller 444 (or controller 477, as the case may be) detects fault conditions or other unsafe conditions of power source 505 and prevents further use of limited reuse assembly 250.

To charge power source 505, a current is induced in inductive element 1225 when it is placed near another inductive element in a charging base (not shown). This induced current charges power source 505.

FIG. 6 is a cross section view of a limited reuse assembly according to an embodiment of the present invention. In FIG. 6, limited reuse assembly 250 includes mechanical linkage interface 545, actuator shaft 510, actuator 515, power source 505, controller 477, limited reuse assembly housing 255, interface 535, limited reuse assembly interface connector 551, displacement sensor 1215, power source controller 444, and contacts 1235.

In the embodiment of FIG. 6, contacts 1235 interface with contacts on a charging base (not shown) to provide power to power source 505. In one embodiment, contacts 1235 are a mini-USB connection. In another embodiment, they are a CraldeCon™ connector manufactured by Molex®. Other types of connectors may also be used.

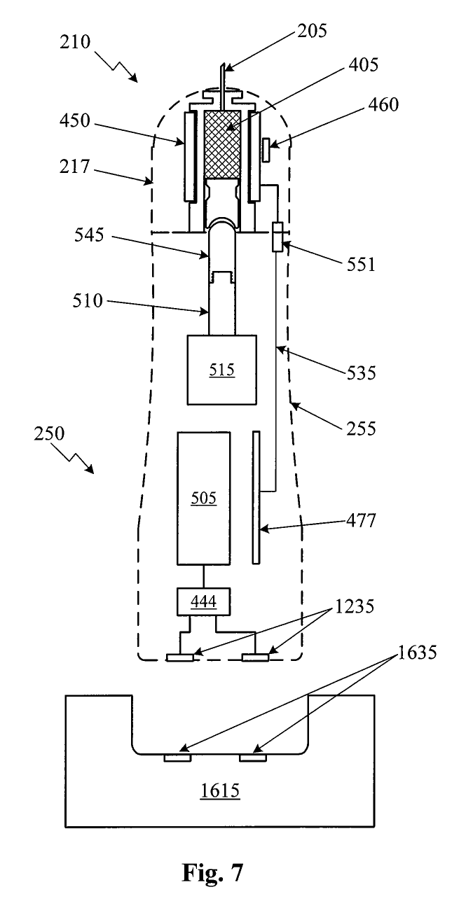

FIG. 7 is a cross section view of a charging base and the limited reuse assembly of FIG. 6 attached to a tip segment. In FIG. 7, a bottom surface of limited reuse assembly 250 interfaces with charging base 1615. When limited reuse assembly 250 is resting in charging base 1615, power source 505 can be charged. After being charged, limited reuse assembly 250 can be removed from charging base 1615. In one embodiment of the present invention, contacts 1635 mate with contacts 1235 to form a connection between charging base 1615 and the medical device (limited reuse assembly 250 and tip segment 210). In one embodiment, contacts 1235 and 1635 are mini-USB connectors. In another embodiment, they are a CraldeCon™ connector manufactured by Molex®.

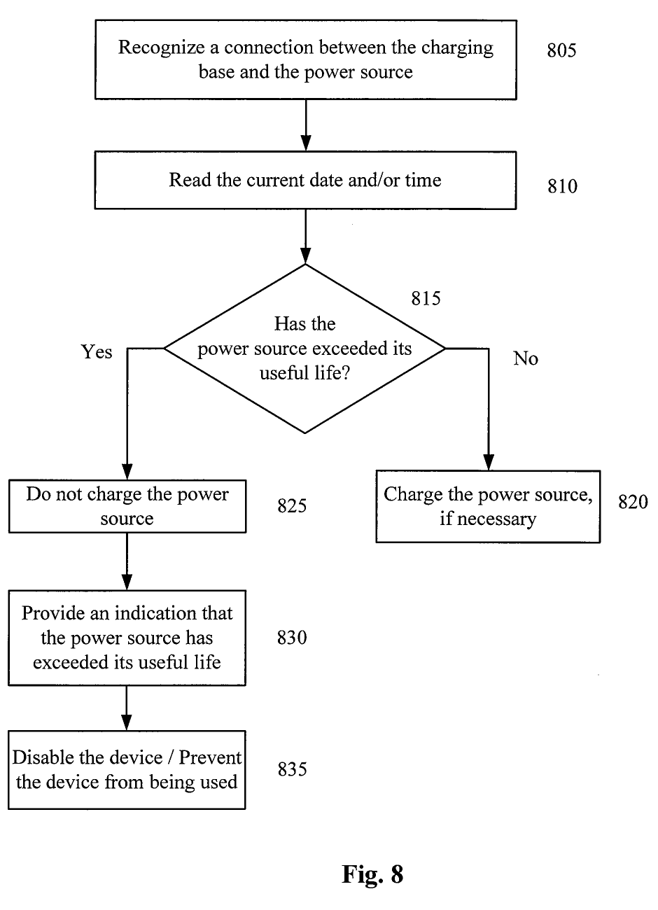

FIG. 8 is a flow chart of one method of determining when a power source has expired according to the principles of the present invention. In 805, a connection between a charging base and a power source is recognized. Typically, a battery pack or limited reuse assembly is interfaced with the charging base. If an RFID system is utilized, then an RFID connection is implemented as described above. If a wired connection is utilized (such as a USB or mini-USB connection), then the connectors are physically coupled. In 810, the current date and/or time is read from the clock. Typically, a real time clock is incorporated into the battery pack, limited reuse assembly, or charging base. This real time clock preferably provides the current date and may also provide the current time. The output of the clock may be read by a controller or other suitable circuitry.

In 815, the output of the clock (date and/or time) is compared to the manufacturing or in-service date and/or time of the power source. Since a given power source has a known useful life, a comparison between the current date and/or time and the manufacturing date and/or time reveals how old the power source is. For example, when the power source is a lithium ion battery, its useful life is measured from its manufacturing date. Many factors affect the useful life of a typical lithium ion battery including the number of times it is charged and discharged, the temperature at which it is stored and used, the charge level at which the battery is kept, and other factors. A useful life can be preset or predetermined at the factory based on typical battery usage. In a more conservative case, the preset useful life may be reduced to ensure patient safety. For example, if the typical life of a lithium ion battery used in a medical device is two years, then a more conservative useful life of one and a half years may be used.

If the power source is older than its useful life, then it may be unsafe to use. In 825, the power source is not charged. In 830, an indication is provided that the power source is expired. In 835, the device is optionally disabled or switched off until a new power source is installed. If the power source has not exceeded its useful life, then in 820, the power source is charged if necessary.

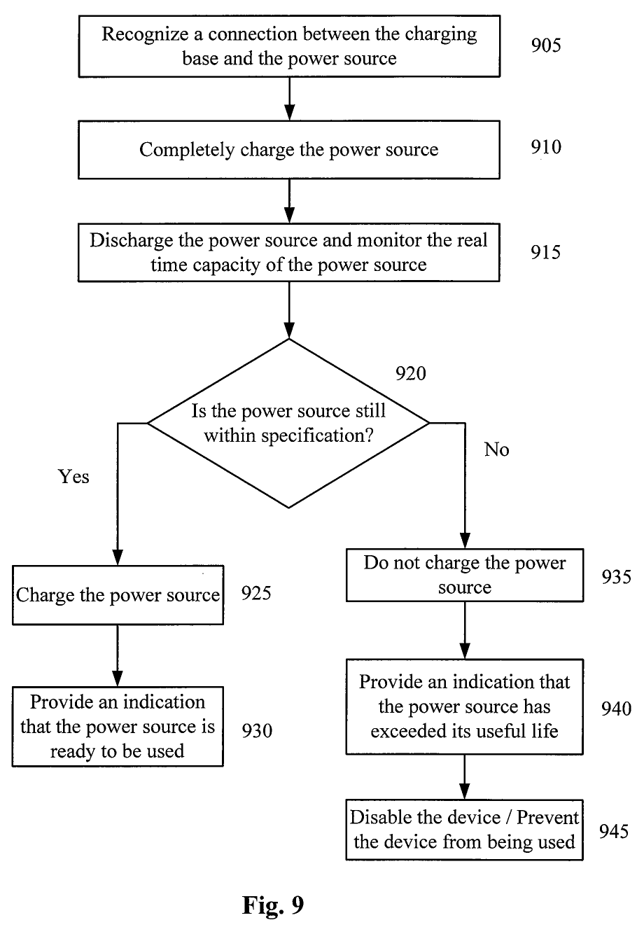

FIG. 9 is a flow chart of one method of maintaining a power source according to the principles of the present invention. In 905, a connection between the power source and the charging base is recognized. This connection is established as referred to in FIG. 8. In 910, the power source is completely charged. In 915, the power source is discharged and the real time capacity of the power source is monitored. The power source is typically discharged into a known load. The time that it takes to discharge the power source and the amount of the discharge are monitored. In the case of a lithium ion battery, the discharge may not be a complete discharge. As is commonly known, a battery loses its capacity to hold a charge as it ages. Depending on how the battery is used, this loss in charge capacity can be gradual or more pronounced over time. Cycling the battery periodically to determine the actual amount of charge that it is capable of holding provides a useful reference point in determining the safety of using that battery.

In 920, the information from the charge and discharge cycle is used to determine if the power source is still within specification. For example, when the power source is a lithium ion battery, it may not be able to hold a charge sufficient to safely perform a procedure. In such a case, the power source is not within specification. If the power source is not within specification, then in 935, the power source is not charged. In 940, an indication is provided that the power source has expired or is not longer useful. In 945, the medical device is optionally disabled or shut off. If the power source is within specification, then in 925, the power source is charged. In 930, after the power source is charged, an indication is provided that the power source is ready to be used.

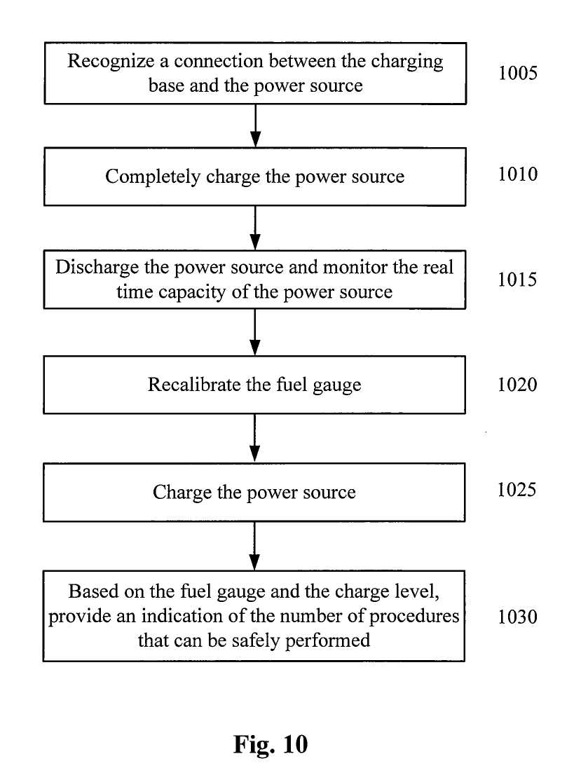

FIG. 10 is a flow chart of one method of maintaining a power source according to the principles of the present invention. In 1005, a connection between the power source and the charging base is recognized. This connection is established as referred to in FIG. 8. In 1010, the power source is completely charged. In 1015, the power source is discharged and the real time capacity of the power source is monitored. The power source is typically discharged into a known load. The time that is takes to discharge the power source and the amount of charge are monitored.

In 1020, the fuel gauge is recalibrated using the information from the charge and discharge cycle. The fuel gauge measures the amount of charge that the power source is capable of holding. As the power source ages, its charge capacity decreases. This decrease in charge capacity is reflected in the fuel gauge. For example, when a lithium ion battery is new, it can hold a full charge that may be able to provide power for ten procedures. As the battery ages, its ability to hold a charge decreases. If the battery can only hold 60% of its original charge, then it may only be able to safely provide power for six procedures. In this case, the fuel gauge is recalibrated to 60% of its original value. The fuel gauge can then be used to determine if it is safe to perform a number of procedures. In 1025, the power source is charged. In 1030, an indication of the number of procedures that the power source can power is provided based on the fuel gauge and/or charge level.

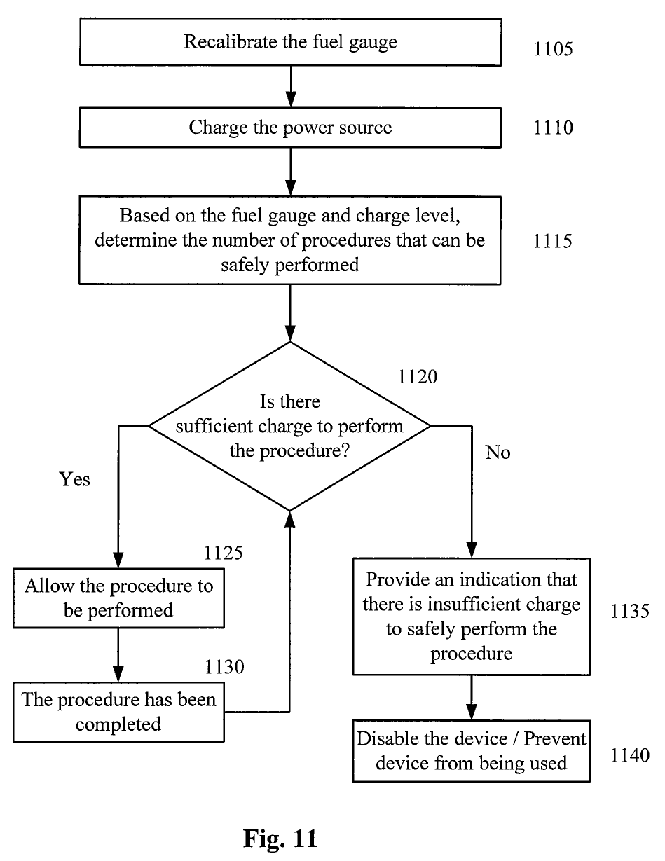

This safety monitoring is further described in FIG. 11. FIG. 11 is a flow chart of one method of maintaining a power source according to the principles of the present invention. In 1105, the fuel gauge is recalibrated as described above. In 1110, the power source is charged. In 1115, the number of procedures that can be safely performed is determined. As mentioned above, this number is determined from the fuel gauge and/or charge level. In 1120, it is determined if there is enough charge to perform a procedure safely. If there is enough charge to perform the procedure safely, then in 1125, the procedure is allowed to be performed. In 1130, after the procedure has been completed, the process returns to 1120. In this manner, one charge may provide enough power for several procedures. For example, a complete charge may provide enough power to perform ten procedures safely. In such a case, the ten procedures can be performed before the power source is recharged. If there is not sufficient charge to perform the procedure safely, then in 1135, an indication that there is an insufficient charge is provided. In 1140, the device is disabled so that the procedure is not performed.

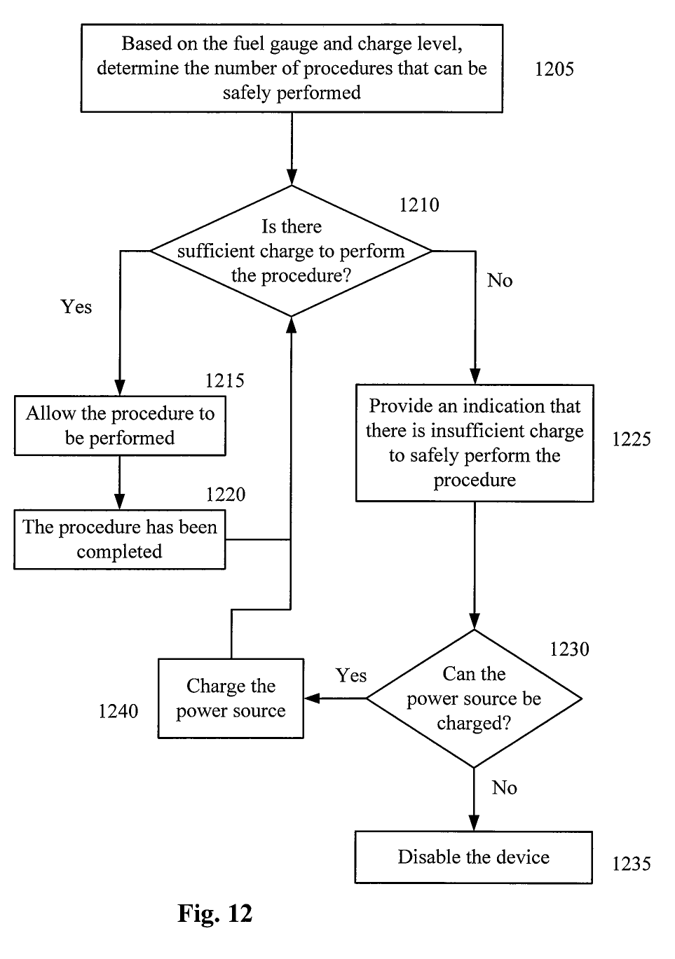

FIG. 12 is a flow chart of one method of maintaining a power source according to the principles of the present invention. In 1205, the number of procedures that can be safely performed is determined. As mentioned above, this number is determined from the fuel gauge and/or charge level. In 1210, it is determined if there is enough charge to perform a procedure safely. If there is enough charge to perform the procedure safely, then in 1215, the procedure is allowed to be performed. In 1220, after the procedure has been completed, the process returns to 1210. In this manner, one charge may provide enough power for several procedures. For example, a complete charge may provide enough power to perform ten procedures safely. In such a case, the ten procedures can be performed before the power source is recharged. If there is not sufficient charge to perform the procedure safely, then in 1225, an indication that there is an insufficient charge is provided. In 1230, it is determined if the power source can be charged. Typically, the power source is simply low and needs to be charged. If the power source can be charged (for example, it has not exceeded its useful life), then in 1240, the power source is charged. After the power source has been charged, the process returns to 1210. In 1230, if the power source cannot be charged (for example, the power source has exceeded its useful life), then in 1235, the device is disabled so that a procedure cannot be performed.

From the above, it may be appreciated that the present invention provides an improved system and method for monitoring and maintaining a power source for use with a medical device. The present invention provides a charging base and associated circuitry for monitoring the condition of a power source for the safe operation of a medical device. The present invention is illustrated herein by example, and various modifications may be made by a person of ordinary skill in the art.

While described in terms of an ophthalmic injection device, the present invention is suitable for use in any type of battery powered medical device. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A safety charging system for a battery-operated medical device comprising:
a power source;
a first connection arrangement coupled to the power source, the first connection arrangement for providing an electrical and data connection;
a charging base for charging a power source that powers a medical device, the charging base comprising a second connection arrangement for providing an electrical and data connection between the medical device and the charging base, and charge circuitry for charging the power source;
a clock for providing a current date; and
control logic for implementing maintenance and charging of the power source.

2. The charging system of claim 1 wherein the power source is a battery.

3. The charging system of claim 1 wherein the charging base further comprises power conditioning circuitry.

4. The charging system of claim 1 wherein the first and second connection arrangements are implemented with a wired set of connectors.

5. The charging system of claim 1 wherein the first and second connection arrangements are implemented wirelessly.

6. The charging system of claim 1 further comprising:
a memory associated with the power source, the memory for storing a date associated with the power source.

7. The charging system of claim 1 wherein the control logic recalibrates a fuel gauge indicating a charge level of the power source.

8. The charging system of claim 1 wherein the control logic prevents the medical device from being used if the power source is out of specification.

9. The charging system of claim 1 wherein the control logic schedules discharge and recharge cycles to monitor a condition of the power source.

10. A method of determining whether a power source has expired comprising:
recognizing a connection between a power source and a charging base;
reading a current date;
comparing the current date to a date associated with the power source; and
determining if the power source has exceeded its useful life.

11. The method of claim 10 wherein determining if the power source has exceeded its useful life further comprises:
comparing a difference between the current date and the date associated with the power source to a preset length of time representing a useful life of the power source representative of a length of time during which the power source can safely power a medical device.

12. The method of claim 10 further comprising:
providing an indication that the power source has exceeded its useful life; and
preventing a medical device from being used.

13. A method of maintaining a power source comprising:
recognizing a connection between a power source and a charging base;
charging the power source;
after the power source is charged, discharging the power source;
monitoring a real time capacity of the power source while it is being discharged; and
determining if the power source is within specification.

14. The method of claim 13 wherein determining if the power source is within specification further comprises:
comparing the real time capacity of the power source to a charge capacity needed to safely perform a procedure.

15. The method of claim 13 further comprising:
providing an indication that the power source has exceeded its useful life; and
preventing a medical device from being used.

16. The method of claim 13 further comprising:
recalibrating a fuel gauge wherein the fuel gauge indicates a charge that the power source is capable of holding;

17. The method of claim 16 further comprising:
charging the power source a second time to a charge level; and
providing an indication of how many procedures can be performed safely based on the fuel gauge and the charge level.

18. The method of claim 16 further comprising:
determining if a charge level of the power source is sufficient to perform a procedure.

19. The method of claim 17 further comprising:
allowing a procedure to be performed; and
after the procedure has been performed, determining if the charge level of the power source is sufficient to perform another procedure.

20. The method of claim 18 further comprising:
providing an indication that the power source does not have a sufficient charge to perform the procedure; and
preventing a medical device from being used.
